(19) United States
(12) Patent Application Publication
(10) Pub. No.: US 2013/0110564 A1
(43) Pub. Date: May 2, 2013

(54) SPOT PRICING TO REDUCE WORKLOAD IN A DATA CENTER

(71) Applicants: Chris D. Hyser, Victor, NY (US); Martin Arlitt, Calgary (CA); Cullen E. Bash, Los Gatos, CA (US); Tahir Cader, Liberty Lake, WA (US); Richard Shaw Kaufmann, San Diego, CA (US)

(72) Inventors: Chris D. Hyser, Victor, NY (US); Martin Arlitt, Calgary (CA); Cullen E. Bash, Los Gatos, CA (US); Tahir Cader, Liberty Lake, WA (US); Richard Shaw Kaufmann, San Diego, CA (US)

(21) Appl. No.: 13/282,399

(22) Filed: Oct. 26, 2011

(51) Int. Cl. G06Q 10/00

(52) U.S. Cl. 705/7.11

(57) ABSTRACT

Systems and methods of spot pricing to reduce workload in a data center are disclosed. An example method may include determining a runtime financial aspect of a data center. The method may also include adjusting spot pricing to change workload in the data center and enhance associated power consumption based on the runtime financial aspect.

### BACKGROUND

The client/server computing environment continues to expand, as more services are added. Service providers have begun moving to hosted infrastructure as remote access has both grown in capability and functionality, and data centers have become increasingly compliant with standards-based computing. The latest iteration of data center infrastructure includes the so-called “cloud” computing environment. These data centers are highly adaptive and readily scaled to provide a variety of hosted services. As use of data centers continues to increase, however, resource usage is a growing concern (e.g., higher power consumption and the use of water in cooling operations).

In a data center that shares resources across different services and service providers, workload is determined by how many users are using the various services and income is often considered to be a relatively linear function. That is, there is an assumption that hosting service N will cost the same as hosting service N-1. This may be the case when computing resources already powered-on are able to handle an additional workload, because the power and cooling needed to handle this additional workload is incremental and increase proportionally. In such a scenario, the data center operating costs tend to rise by relatively small amounts which can be readily attributed to the service providers adding workload.

But this assumption is not always valid. When the equipment that is already powered-on is at capacity, any additional increase in workload has to be handled by powering on additional information technology (IT) or facilities equipment. In this case, power and cooling resource consumption at the data center may increase disproportionately, even if the additional load is only incremental. This is particularly acute if less efficient equipment needs to be used (e.g., a diesel generator to provide additional electricity). In these circumstances, a linear model cannot accurately predict the associated rise in operating cost.

### BRIEF DESCRIPTION OF THE DRAWINGS

FIG. 1 is a high-level illustration of an example data center that may implement spot pricing to reduce workload.

FIG. 2 is a high-level illustration of an example networked computer system that may be utilized for spot pricing to reduce workload in a data center.

FIG. 3 shows an example architecture of machine readable instructions, which may be executed for spot pricing to reduce workload in a data center.

FIGS. 4a-b are plots illustrating use of spot pricing to reduce workload in a data center.

FIGS. 5a-b are flowcharts illustrating example operations of spot pricing to reduce workload in a data center.

### DETAILED DESCRIPTION

In a data center, even small increases in workload may necessitate bringing more equipment online, increasing the associated use of power and cooling resources disproportionally. That is, the cost of supporting additional workload may increase non-linearly (at a rate or increment greater than a linear model would predict).

By way of illustration, a data center may be configured to operate with a particular type and number of equipment that has been determined to provide sufficient computing resources for typical demand. There is generally some over-capacity factored into this baseline configuration, such that incremental increases in load can be handled without having to power on and off additional resources in response to changes in demand. Accordingly, incremental increases in demand may result in incremental increases in operating costs. These incremental increases can be readily anticipated using a linear model, and priced accordingly.

But there is a point when the baseline configuration can no longer handle further increases in demand. At this point, it may be necessary to power on additional equipment. Powering on additional equipment results in a step-function increase in resource consumption. Not only may powering on additional IT equipment result in a substantial increase in electrical power consumption, but may also result in additional cooling resources being deployed.

Multiple cooling resources may be used for cooling operations in the data center. These may include relatively inexpensive cooling resources, such as air movers (e.g., fans and blowers) that utilize outside or ambient air for cooling operations. Cooling resources may also include more expensive refrigeration, air conditioning, and evaporative cooling, to name only a few examples of more resource-intensive cooling techniques. While the inexpensive air movers may be able to provide sufficient cooling for the data center's baseline configuration, powering on additional equipment may necessitate deploying the more expensive cooling techniques.

Accordingly, even incremental changes in workload can change the operating costs beyond that which can be accurately predicted using a linear model. It is noted that operating costs may increase both in economic terms (e.g., financial return), and social or sustainability terms (e.g., greenhouse gas emissions).

The systems and methods described herein use more extensive modeling to predict step function increases in resource consumption in a data center in order to optimize the work being performed while reducing the operating costs. The systems and methods may be used to remove sufficient workload such that computing resources and/or cooling resources can be taken offline. The systems and methods may also be used to prevent or delay having to power on additional computing and/or cooling resources.

In an example, the data center operator may implement spot pricing based on output from the systems and methods described herein, to achieve the desired outcome, such as complying with sustainability goals, regulations, and profit projections. The data center operator may also offer incentives to customers to shed workload so that more expensive cooling resources can be taken offline. In another example, the data center operator may reduce quality of service (QoS).

Before continuing, it is noted that the term “spot pricing” is used herein to mean the application of a “spot price” or “spot rate.” The spot price (or rate) is commonly used in economics to price commodities, securities, or currencies, and is quoted for immediate (i.e., on the “spot”) payment and delivery. As used herein, the term “spot pricing” indicates expectations of a future price movement, such as the expectation that operating costs for a data center will increase (or decrease) based on expected workload, the current configuration, and any equipment that may need to be powered on (or off) based on future workload.

It is noted that as used herein, the terms “includes” and “including” mean, but is not limited to, “includes” or “including” and “includes at least” or “including at least.” The term “based on” means “based on” and “based at least in part on.”

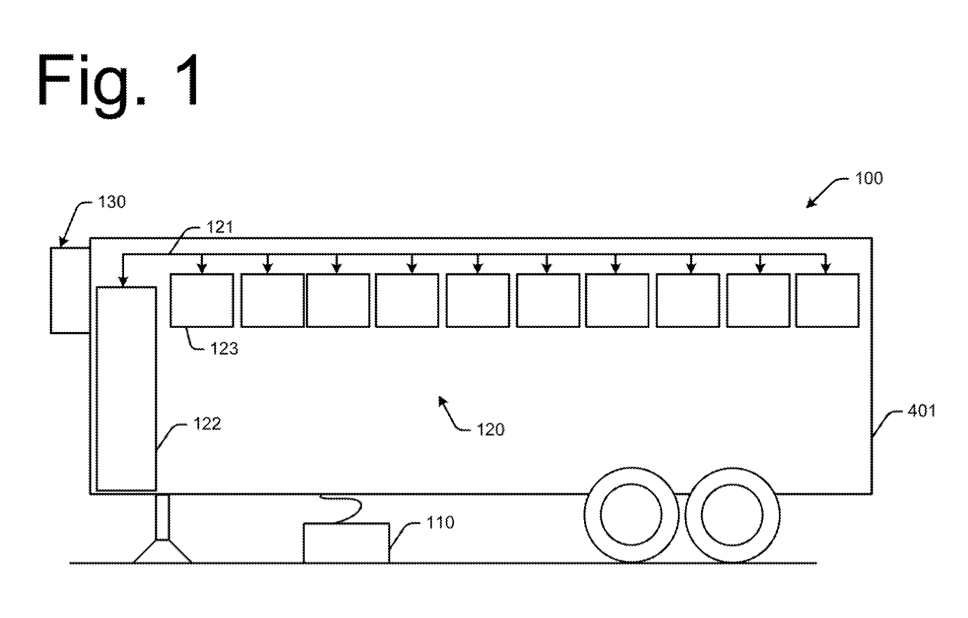

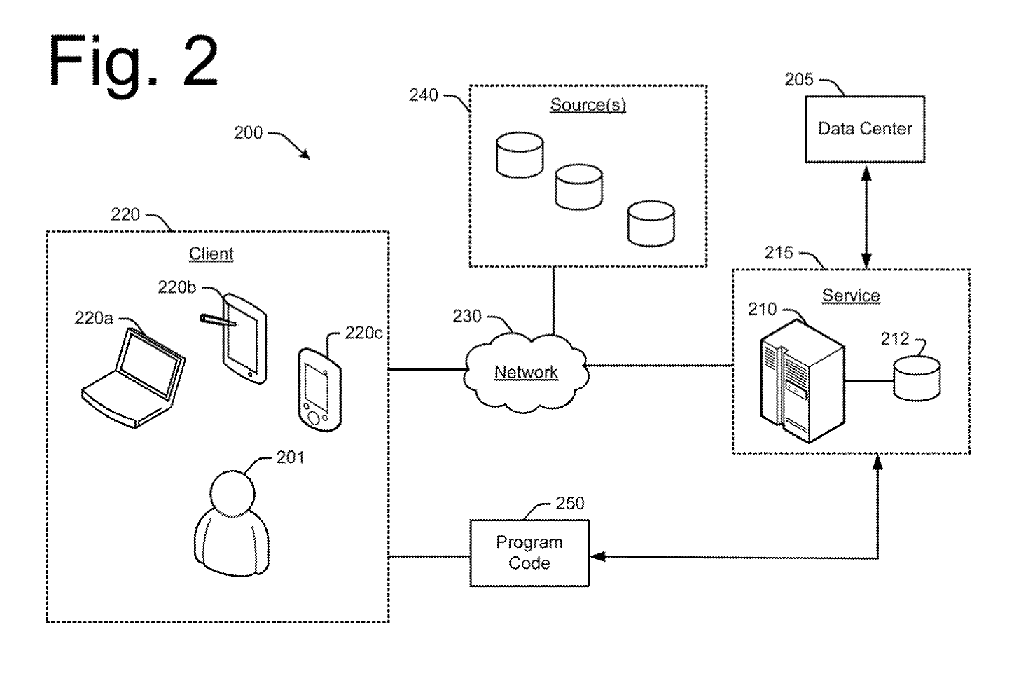

FIG. 1 is a high-level illustration of an example data center 100 that may implement spot pricing to reduce workload. Modern data centers offer a consolidated environment for providing, maintaining, and upgrading hardware and software for an enterprise, in addition to more convenient remote access and collaboration by many users. Modern data centers also provide more efficient delivery of computing services. For example, it is common for the processor and data storage for a typical desktop computer to sit idle over 90% of the time during use. This is because the most commonly used applications (e.g., word processing, spreadsheets, and Internet browsers) do not require many resources. By consolidating processing and data storage in a data center, the same processor can be used to provide services to multiple users at the same time.

Data centers can include many different types of computing resources, including processing capability, storage capacity, and communications networks, just to name a few examples of equipment and infrastructure. The number and type of computing resources provided by a data center may depend at least to some extent on the type of customer, number of customers being served, and the customer requirements. Data centers may be any size. For example, data centers may serve an enterprise, the users of multiple organizations, multiple individual entities, or a combination thereof.

The example data center 100 shown in FIG. 1 is a “containerized” data center. A containerized data center is an example of a smaller data center used by a single customer (albeit having multiple users), or by a limited number of customers. The containerized data center is a more recent development in data centers. Although not limiting, an example containerized data center allows computing resources to be provided on a mobile basis (e.g., moved from one site to another on an as-needed basis such as for exploration and/or military purposes). An example containerized data center includes all of the equipment mounted in a semi-truck trailer that can be readily moved to desired location(s).

Containerized data centers, such as the example data center shown in FIG. 1, may be used by enterprises having to deploy and move data services to field locations that change over time. For example, the military and oil and gas exploration entities may benefit from the use of containerized data centers. Often, the areas in which these entities are operating are many, and change over time. So it may not be feasible to build dedicated facilities for hosting data services for these entities. In addition, there may be restrictions that prevent the construction of dedicated data centers at some field locations. Other users may also utilize containerized data centers.

The systems and methods described herein are well-suited for use with containerized data centers, given the limited resources that may be available in some locations (e.g., electricity provided by an on-site power generator 110). But the systems and methods are not limited to use with containerized data centers, and may in fact be used with any data center.

Regardless of the physical configuration and location of the data center 100, communications in data centers are typically network-based. The most common communications protocol is the Internet protocol (IP), however, other network communications may also be used. Network communications may be used to make connections with internal and/or external networks. Accordingly, the data center 100 may be connected by routers and switches and/or other network equipment 121 that move network traffic between the servers and/or other computing equipment 122, data storage equipment 123, and/or other electronic devices and equipment in the data center 100 (referred to herein generally as “computing infrastructure” 120).

Operating the infrastructure results in heat generation. Accordingly, the data center 100 may also include various environmental controls, such as equipment used for cooling operations in the data center. The cooling equipment is referred to herein generally as the “cooling infrastructure” 130. The cooling infrastructure may include relatively inexpensive cooling resources, such as air movers (e.g., fans and blowers) that utilize outside or ambient air for cooling operations. Cooling resources may also include more expensive refrigeration, air conditioning, and evaporative cooling, to name only a few examples of more resource-intensive cooling techniques. The type and configuration of cooling infrastructure may depend to some extent on the type and configuration of the computing infrastructure. The cooling infrastructure may also depend to some extent on the computing infrastructure which is “online” or operating, the use of computing infrastructure (e.g., periods of high use and/or low use), and external conditions (e.g., the outside temperature).

It is noted that the data center 100 is not limited to use with any particular type, number, or configuration of facilities infrastructure. The data center 100 shown in FIG. 1 is provided as an illustration of an example operational environment, but is not intended to be limiting in any manner.

The main purpose of the data center 100 is providing facility and computing infrastructure for customers (e.g., service providers), and in turn the end-users with access to computing resources, including but not limited to data processing resources, data storage, and/or application handling. A customer may include anybody (or any entity) who desires access to resource(s) in the data center 100. Although it is noted that in some cases the set of end users is restricted, e.g., in the oil and gas example the services would not be accessible to the general public. The customer may also include anybody who desires access to a service provided via the data center 100. Providing the client access to the resources in the data center 100 may also include provisioning of the resources, e.g., via file servers, application servers, and the associated middleware.

During use, customers and end-users (referred to generally herein as “users”) may desire access to the data center 100 for a particular purpose. Example purposes include executing software and providing services which were previously the exclusive domain of desktop computing systems, such as application engines (e.g., word processing and graphics applications), and hosted business services (e.g., package delivery and tracking, online payment systems, and online retailers), which can now be provided on a broader basis as hosted services via data center(s).

Use of the data center 100 by customers may be long term, such as installing and executing a database application, or backing up data for an enterprise: The purpose may also be short term, such as a large-scale computation for a one-time data analysis project. Regardless of the purpose, the customers may specify a condition for carrying out the purpose.

The condition may specify a single parameter, or multiple parameters for using resources in the data center 100. Based on these conditions, the data center 100 can be configured and/or reconfigured as part of an ongoing basis to provide the desired computing resources for the user. For example, the condition for utilizing resources in the data center 100 may describe the storage requirements to install and execute a database application. In another example, the condition may specify more than one parameter that needs to be provided as part of a service (e.g., both storage and processing resources).

The data center 100 is typically managed by an operator. An operator may include anybody (or any entity) who desires to manage the data center 100. For purposes of illustration, an operator may be a network administrator. The network administrator in charge of managing resources for the data center 100, for example, to identify suitable resources in the data center 100 for deploying a service on behalf of a customer. In another example, the operator may be an engineer in charge of managing the data center 100 for an enterprise. The engineer may deploy and manage processing and data storage resources in the data center 100. The engineer may also be in charge of accessing reserved resources in the data center 100 on an as-needed basis. The function of the operator may be partially or fully automated, and is not limited to network administrators or engineers.

FIG. 2 is a high-level illustration of an example networked computer system 200 that may be utilized by an operator for spot pricing to reduce workload in a data center 205 (e.g., the data center 100 shown in FIG. 1). System 200 may be implemented with any of a wide variety of computing devices for monitoring equipment use, determining spot pricing for customers, and reducing workload in the data center 205.

Example computing devices include but are not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 200 may include a host 210 providing a service 215 accessed by an operator 201 via a client device 220. For purposes of illustration, the service 215 may be implemented as a data processing service executing on a host 210 configured as a server computer with computer-readable storage 212. The service 215 may include application programming interfaces (APIs) and related support infrastructure. The service 215 may be accessed by the operator to manage the data center 205, and more specifically, to implement spot pricing to reduce workload in the data center 205. The operator 201 may access the service 215 via a client 220. The client 220 may be any suitable computer or computing device 220a-c capable of accessing the host 210.

Host 210 and client 220 are not limited to any particular type of devices. Although, it is noted that the operations described herein may be executed by program code residing entirely on the client (e.g., personal computer 220a), in other examples (e.g., where the client is a tablet 220b or other mobile device 220c) the operations may be better performed on a separate computer system having more processing capability, such as a server computer or plurality of server computers (e.g., the host 210) and only accessed by the client 220.

In this regard, the system 200 may include a communication network 230, such as a local area network (LAN) and/or wide area network (WAN). The host 210 and client 220 may be provided on the network 230 via a communication protocol. Such a configuration enables the client 220 to access host 210 directly via the network 230, or via an agent, such as another network (e.g., in remotely controlled applications). In an example, the network 230 includes the Internet or other mobile communications network (e.g., a 3G or 4G mobile device network). Network 230 may also provide greater accessibility to the service 215 for use in distributed environments, for example, where more than one operator may have input and/or receive output from the service 215.

The service 215 may be implemented in part via program code 250. In an example, the program code 250 is executed on the host 210 for access by the client 220. For example, the program code may be executed on at least one computing device local to the client 220, but the operator is able to interact with the service 215 to send/receive input/output (I/O) in order to manage workload in the data center 205.

Before continuing, it is noted that the computing devices described above are not limited in function. The computing devices may also provide other services in the system 200. For example, host 210 may also provide transaction processing services and email services and alerts or other notifications for the operator via the client 220.

During operation, the service 215 may be provided with access to local and/or remote source(s) 240 of information. The information may include information for the data center 205, equipment configuration(s), power requirements, and cooling options. Information may also include current workload and requests to increase workload. The information may originate in any manner, including but not limited to, historic data and real-time monitoring.

The source 240 may be part of the service 215, and/or the source may be physically distributed in the network and operatively associated with the service 215. In any implementation, the source 215 may include databases for, providing the information, applications for analyzing data and generating the information, and storage resources for maintaining the information. There is no limit to the type or amount of information that may be provided by the source. In addition, the information provided by the source 240 may include unprocessed or “raw” data, or data may undergo at least some level of processing before being provided to the service 215 as the information.

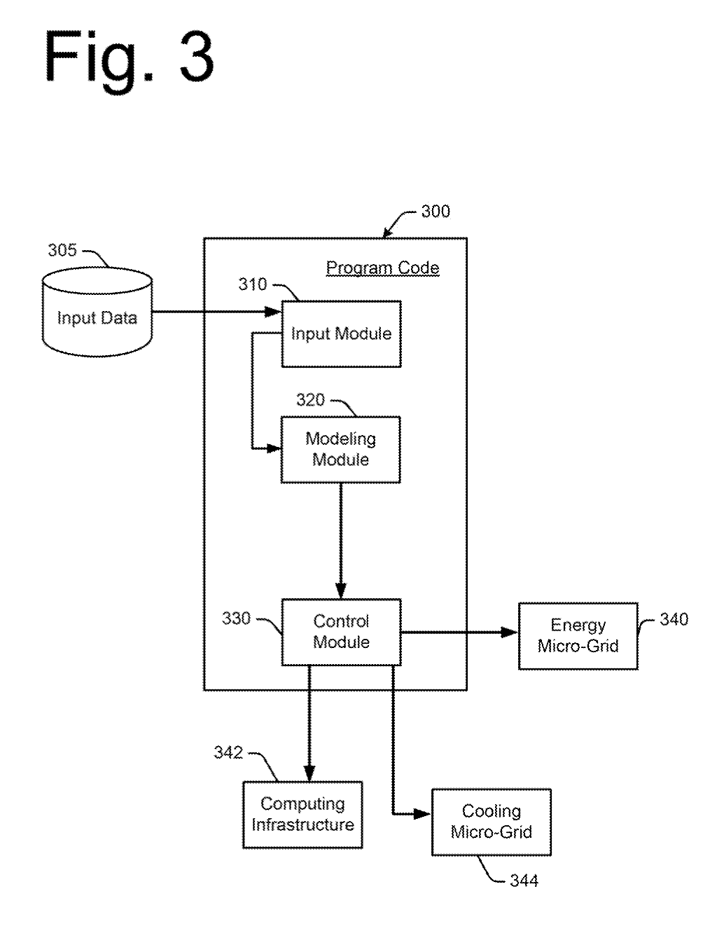

As mentioned above, operations for spot pricing to reduce workload in the data center may be embodied at least in part in executable program code 250. The program code 250 used to implement features of the systems and methods described herein can be better understood with reference to FIG. 3 and the following discussion of various example functions. However, the operations are not limited to any specific implementation with any particular type of program code.

FIG. 3 shows an example architecture 300 of machine readable instructions, which may be executed for spot pricing to reduce workload in a data center. The program code discussed above with reference to FIG. 2 may be implemented in machine-readable instructions (such as but not limited to, software or firmware). The machine-readable instructions may be stored on a non-transient computer readable medium and are executable by one or more processor to perform the operations described herein. It is noted, however, that the components shown in FIG. 3 are provided only for purposes of illustration of an example operating environment, and are not intended to limit implementation to any particular system.

In an example, the program code executes the function of the architecture of machine readable instructions as self-contained modules. These modules can be integrated within a self-standing tool, or may be implemented as agents that run on top of an existing program code. In an example, the architecture of machine readable instructions may include an input module 310 to receive input data 305, and a modeling module 320.

Modeling module 320 may be utilized to determine a runtime financial aspect of a data center, and adjust spot pricing to reduce workload in the data center and associated power consumption based on the runtime financial aspect. The runtime financial aspect includes dynamic trade-offs between the income derived from adding or removing workload, versus the cost of utilizing more computing and cooling infrastructure.

During operation, the modeling module 320 may map existing workload to infrastructure use in the data center, and model expected workload for infrastructure use in the data center, e.g., according to a non-linear function. Based on current and projected use of data center infrastructure, spot pricing for utilizing the data center may be adjusted for customers using the data center.

Spot pricing may be based on power consumption and/or heat load. In an example, spot pricing may be increased to encourage use of a more efficient configuration of infrastructure in the data center, before having to utilize a less efficient infrastructure configuration.

In an example, the modeling module 320 compares both real-time and planned usage of the data center infrastructure, with infrastructure configuration(s). For example, usage information may include an inventory of resources in the data center and corresponding power and other resource consumption (e.g., water use). The inventory may also include information about alternative configurations of the infrastructure, such as use allocations (e.g., virtual versus actual) and interoperability between components.

Any level of granularity may be implemented for analysis. For example, the modeling module 320 may analyze information for specific equipment. In another example, the modeling module 320 may analyze information about classes of devices (e.g., the storage devices and all middleware for accessing the storage devices). The modeling module 320 may take into consideration factors such as availability, and in addition, specific characteristics of the resources such as, logical versus physical resources.

The modeling module 320 may be operatively associated with a control module 330. The control module 330 utilizes output from the modeling module to implement equipment (IT infrastructure and/or cooling systems) configurations in the data center. In an example, the control module 330 may be associated with an energy micro-grid 340, computing infrastructure 342 and/or cooling micro-grid 344 in the data center.

It is noted that the energy and cooling micro-grids supply resources (power and cooling resources) to the data center. There are internal controllers in the micro-grids that ensure the resources are provided efficiently when and where these are needed. Module 320 can model the operation of the micro-grids and can feed that information into control module 330, but the mirco-grids are not under the direct control of control module 330 In addition, control module 330 can communicate with all three of 340, 342, and 344 in parallel, though it is not required that 330 communicate with all three of 340, 342, and 344.

The control module 330 may determine if there is a supported configuration of the data center infrastructure. A supported configuration is a configuration of the infrastructure which satisfies a condition at least in part. For example, the condition may specify a maximum power consumption and/or use of cooling resources which meet a stated financial and/or social goal.

In an example, the control module 330 may identify a plurality of supported configurations in the data center which satisfy the condition. The control module 330 may also identify preferred configuration(s), and/or alternative configuration(s). Supported configurations may be evaluated for tiers or levels of service in the data center, to determine if alternative configurations and/or reductions to quality of service may be implemented to support the desired use specified by the condition.

If the control module 330 cannot identify a supported configuration for actual or anticipated use, then spot pricing may be implemented to keep power consumption and/or cooling resources from exceeding a predetermined goal, or reduce usage when feasible.

In an example, selecting a spot price may be based at least in part on satisfying a condition (e.g., a financial or social goal), and/or to achieve a desired configuration of the data center infrastructure. By way of illustration, spot pricing may be adjusted to reduce current workload, and/or quality of service (QoS), before workload exceeds a threshold. The spot price may be used to motivate users to come back at a different time (e.g., when the spot price is lower due to less demand for data center resources), or to accept lower QoS, which can be provided more cost effectively.

Accordingly, increasing the spot pricing may reduce the need for, or altogether prevent having to bring supplemental cooling online. In turn, adjustments to the spot pricing reduces aggregate demand in the data center, and associated operating costs.

Spot pricing and adjustments to spot pricing may be presented to a customer and/or operator, e.g., as an incentive to reduce workload. Spot pricing may also be automatically implemented, e.g., if workload is not reduced. In another example, spot pricing may be implemented using a combination of both automatic and manual selection techniques.

In some use cases, virtualized workload trade-offs can be made in terms of powering additional physical servers versus raising the spot price to shrink load, or using incentives to encourage use which meets the condition.

The program code described herein may also be used to generate an exception list. The exception list may identify an incompatibility between workload and desired use of the data center. As such, the exception list may be used to identify change(s) that may be implemented to the infrastructure that would enable the data center to operate within predetermined parameters.

The program code described herein may also be used to generate an audit report. The audit report may be used to audit resource consumption in the data center. For example, the audit report may identify incompatibilities between infrastructure and use trends which may lead to the pre-threshold or actual threshold being exceeded.

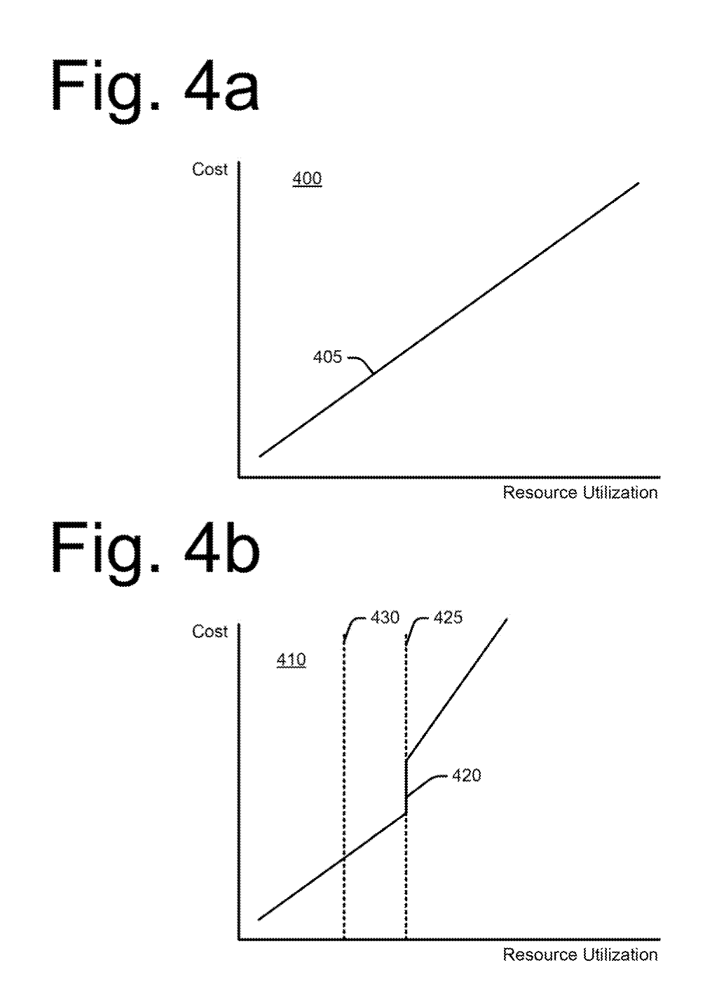

FIGS. 4a-b are plots illustrating use of spot pricing to reduce workload in a data center. FIG. 4a is a plot 400 of a linear model 405 which represents workload associated with various services as directly proportional to the underlying IT equipment. In a data center that sells services, income is not always a linear function of the service(s) being performed. Instead, mapping workload based on actual equipment needs is at times a non-linear function, as shown by the plot 410 in FIG. 4b.

By way of illustration, when the existing powered compute resources can handle additional workload, power requirements and cooling infrastructure costs may rise by relatively small amounts. This increase may be modeled according to a linear-function, such as the plot 400 shown in. FIG. 4a. But eventually, additional equipment may need to be turned on in order to handle increased workload. The point 420 at which additional equipment has to be turned on is shown in FIG. 4b, and establishes a threshold 425. When additional equipment needs to be powered on to accommodate the any additional workload, power consumption may increase as a step function, as illustrated in plot 410. In addition, the slope may be the same and/or different than the slope in plot 410 after the threshold 425 has been reached. In plot 410, the slope is shown being steeper than before the threshold 425 is reached, e.g., due to less efficient equipment being powered on at the threshold 425.

This increase in power consumption is attributable, not only to the additional power consumption of the equipment that has been turned on, but also to the increased cooling in the data center. State of the art cooling infrastructure for data centers is based on the use of cooling micro grids that incorporate a multiplicity of cooling resources (e.g. air and water-side economization, “DX units”, and ground-coupled loops). DX units are a special category of mechanical refrigeration units that are typically self-contained. The DX refers to “direct-exchange” and is meant to indicate that air is directly exchanging heat with refrigerant. Contrast this with chillers that are also mechanical refrigeration units, but exchange heat with a secondary working fluid (e.g., water) before ultimately cooling air. Both are used in data centers.

There may also be an external temperature condition that might cause multiple cooling types to be operated simultaneously. For example using mechanical refrigeration to supplement the use of air-side economization when the external ambient temperature increases beyond a pre-defined value or when the workload increases beyond the capacity limits of the air-side economizer.

To reduce the need for more expensive cooling techniques, the infrastructure control systems may use output from the spot pricing models to configure the data center according to an optimal combination of the cooling options. For example, the use of cooling techniques may be determined as a function of operational cost (which can also be a function of external ambient conditions), and current and projected workload in the data center, as illustrated according to a simplified model in FIG. 4b. Increasing the spot price either motivates users to temporarily stop using the service, or makes user pay a premium for the additional operating costs, so that the operator margins are not affected. That is, the profit margin remains linear even though the operating costs are not linear.

In an example, the cost of operating the micro-grid may be used to adjust the spot pricing of cloud compute or other services offered to customers. Increasing the spot price may be used to compensate the data center owner for increased costs associated with the higher workload, e.g., after exceeding the threshold 425. Another goal of these pricing models is reducing workload, such that the heat load in the data center drops, allowing more expensive cooling operations to be taken off the micro-grid. In either of these scenarios, it makes economic sense to raise the spot price, thereby shedding load and shutting off (or not having to turn on) more costly component(s) of the infrastructure.

Increasing the spot price may at least partially (or even entirely) compensate the data center for any increase in operational costs. At the same time, increasing the spot price can result in a reduction in aggregate demand itself, which can subsequently lower operational costs for the data center. Alternatively, a pre-threshold 430 may be used to make adjustments prior to reaching the actual threshold 425. Use of one or more pre-threshold 430 may result in reduced workload before the actual threshold 425 is even reached. In any of these use cases, the net profit increases from the current configuration of computing and/or cooling infrastructures.

The spot price associated with providing data center infrastructure may also be used to provide incentives for customers to decrease their demand (or to increase demand during off-peak times). For example, if workload is increasing in the data center, the operator may issue a notice to service providers to reduce their use of the data center, or reschedule data and processing operations, in exchange for a discount price and/or other incentives (more data center utilization at off-peak times). Incentives may also include offering refunds or rebates after the threshold has been exceeded in order to reduce workload again to below the threshold.

In some use cases, even if the price is increased, shedding load may reduce the total financial return. However, this loss in profits may be offset by the data center no longer incurring the additional cost of running a more expensive component on the micro-grid.

It is noted that the systems and methods are not intended to only focus on reducing workload, but rather “changing” workload. The mechanism described herein attempts to keep the data center operator's profit margin within acceptable bounds. The main concern is that as the data center reaches capacity of certain resources, the operating costs go up for any additional workload accepted. Thus, the operator may want to use spot pricing to either “encourage” customers not to add to the workload at the current time, or to pass along the additional costs to the service providers, such that the data center operator maintains their profit margin.

Similarly, when the operating costs decrease, the data center operator may decide to lower the spot price to entice customers to bring more workload. An example where operational costs may change even if the workload does not change, is with respect to cooling. For purposes of illustration, during a hot afternoon, the data center may rely heavily on expensive chiller units. However, during the evening the outside temperature may drop, enabling outside air to provide cooling for the data center (and one or more chillers to be turned off). This reduces the operating costs, and enables the data center operator to drop the spot price in an attempt to add further workload during these times and offset that workload during hotter temperatures.

In the data center environment, at least three things contribute to the operating costs. These include the IT equipment, the cooling sources, and the power sources. For example, some servers consume more power than others (or consume relatively more power at low utilization than at high utilization). Accordingly, the operator may adjust the spot price upwards if a less efficient server needs to be turned on. Similarly, if a chiller is needed for cooling, the spot price can also be changed to reflect this operating condition.

In addition, if the data center operates with a micro-grid of power sources (e.g., utility grid, solar, wind, biogas), then there may also be times when less expensive power sources are exhausted. Accordingly, the operator can change the spot price to shed workload to avoid using a more expensive source, or pass the cost on to the customer. Similarly, at some point the operator may have excess supply of a less expensive power source, and thus be able to lower the spot price to entice customers to start using more data center resources.

Before continuing, it should be noted that the examples described above are provided for purposes of illustration, and are not intended to be limiting. Other devices and/or device configurations may be utilized to carry out the operations described herein.

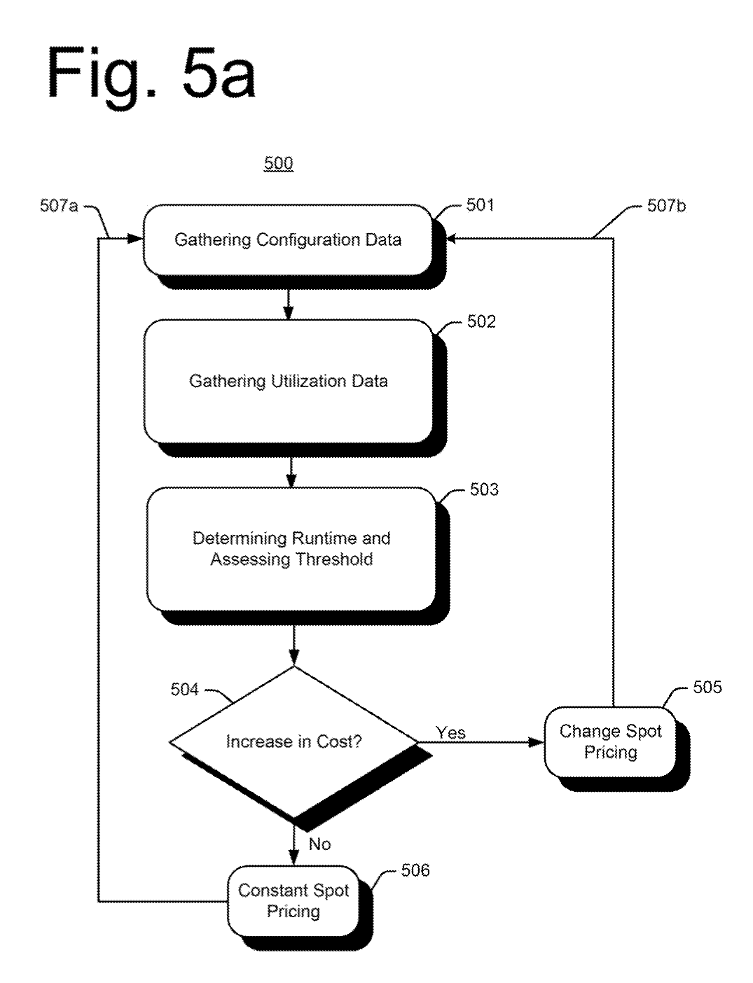

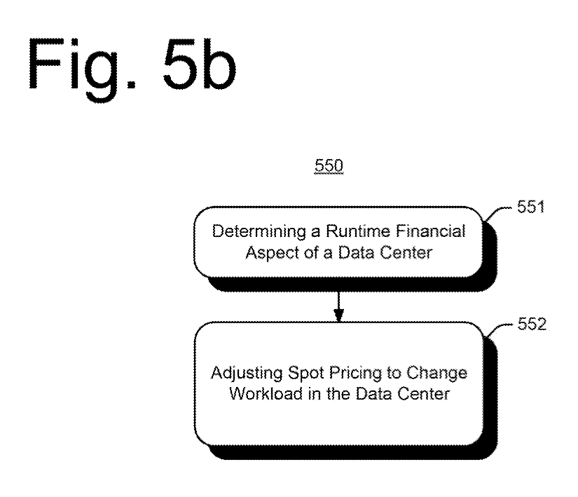

FIGS. 5a-b are flowcharts illustrating example operations of spot pricing to reduce workload in a data center. Operations 500 and 550 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

With reference to FIG. 5a, operation 501 includes gathering data on the configuration of the data center IT and facilities equipment (e.g., what equipment is currently powered on/off). Similarly, operation 502 includes gathering data on the current utilization levels. Operation 503 includes determining the runtime financial aspect, and assessing whether a threshold is about to be exceeded. A determination is made in operation 504 whether the next piece of equipment to be powered on is expected to cause a step up in the operational cost. This step up may be significant, for example, substantially more than would have been anticipated using a linear model and noticeable to the operator. If the assessment is “yes,” then in operation 505 the spot price is changed. If the assessment is “no,” then in operation 506 the spot price remains constant. Return paths 507a and 507b show the process looping back to operation 501 for gathering updated data.

It is noted that spot price can be raised to push away new load to prevent disproportional increase in cost, and/or to ensure that accepted new load compensates for the increase in cost. While technically this may not cause the price to drop, the price may drop because of other business considerations (e.g., the need to be price competitive). A minimum spot price may be determined which is still profitable and keeps the load at a “sweet” spot in the load and cost curves for the data center.

A variety of means can be used to cause a price decrease. By way of example, if the spot price is raised to stay at the “sweet” spot on the load/coast curves for profit reasons, then if the load drops and the spot price is not lowered, then the data center can make a larger profit. Alternatively, the spot price can be decreased and the savings passed along to the data center customer.

With reference to FIG. 5b, operation 551 includes determining a runtime financial aspect of a data center. In an example, the runtime financial aspect is based on real-time actual workload data for a micro-grid in the data center.

Operation 552 includes adjusting spot pricing to change workload in the data center and optimize or enhance associated power consumption based on the runtime financial aspect. In an example, the spot pricing is adjusted to compensate for increased operational costs according to a non-linear function. In another example, the spot pricing is adjusted to reduce aggregate demand. In yet another example, the spot pricing is adjusted based on heat load to prevent supplemental cooling.

The operations shown and described herein are provided to illustrate example implementations. It is noted that the operations are not limited to the ordering shown. Still other operations may also be implemented.

Further operations may include mapping existing workload to infrastructure use in the data center. Operations may also include modeling expected workload to infrastructure use in the data center.

Still further operations may include identifying a threshold where future workload increases infrastructure use defined by a step function. Current workload may then be reduced before exceeding the threshold. In an example, quality of service is automatically reduced before exceeding the threshold. In another example, incentives are offered to data center customers to agree to a reduced quality of service before exceeding the threshold.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method comprising:
determining a runtime financial aspect of a data center; and
adjusting spot pricing to change workload in the data center and enhance associated power consumption based on the runtime financial aspect.

2. The method of claim 1, further comprising mapping existing workload to infrastructure use in the data center.

3. The method of claim 1, further comprising modeling expected workload to infrastructure use in the data center.

4. The method of claim 1, further comprising identifying a threshold where future workload increases infrastructure use as defined by a step function.

5. The method of claim 4, further comprising changing current workload before exceeding the threshold.

6. The method of claim 4, further comprising automatically changing quality of service before exceeding the threshold.

7. The method of claim 4, further comprising offering incentives to change quality of service before exceeding the threshold.

8. The method of claim 1, further comprising receiving real-time actual workload data for a cooling micro-grid in the data center.

9. The method of claim 1, wherein the spot pricing is adjusted to compensate for increased operational costs according to a non-linear function.

10. The method of claim 1, wherein the spot pricing is adjusted to change aggregate demand.

11. The method of claim 1, wherein the spot pricing is adjusted based on heat load to prevent supplemental cooling.

12. A system including machine readable instructions stored in a non-transient computer-readable medium, the machine readable instructions comprising instructions executable to cause a processor to:
determine a runtime financial aspect of a data center; and
adjust spot pricing to change workload in the data center and enhance associated power consumption based on the runtime financial aspect.

13. The system of claim 12, wherein the machine readable instructions further comprise instructions executable to cause the processor to:
map existing workload to infrastructure use in the data center; and
model expected workload for infrastructure use in the data center.

14. The system of claim 12, wherein the machine readable instructions further comprise instructions executable to cause the processor to identify a threshold, and either:
change current workload before exceeding the threshold; or
change quality of service before exceeding the threshold.

15. The system of claim 12, wherein the machine readable instructions further comprise instructions executable to cause the processor to identify incentives to change quality of service before exceeding the threshold.

16. The system of claim 12, wherein the spot pricing compensates for increased operational costs using a non-linear function.

17. The system of claim 12, wherein the spot pricing changes aggregate demand.

18. The system of claim 12, wherein the spot pricing is based at least in part on heat load.

19. The system of claim 12, wherein the spot pricing is increased to prevent supplemental cooling.

20. The system of claim 12, wherein the spot pricing is adjusted to utilize more efficient infrastructure in the data center before utilizing less efficient infrastructure in the data center.
